(19) United States
(12) Patent Application Publication
(10) Pub. No.: US 2026/0362484 A1
(43) Pub. Date: Nov. 12, 2026

(54) METHOD AND DEVICE FOR SECONDARY CHANNEL ACCESS OPERATION

(71) Applicant: CANON KABUSHIKI KAISHA, Tokyo (JP)

(72) Inventors: Yuki FUJIMORI, Kanagawa (JP); Pascal VIGER, JANZE (FR); Mickaël LORGEOUX, RENNES (FR)

(21) Appl. No.: 19/515,340

(22) PCT Filed: Sep. 4, 2024
(86) PCT No.: PCT/EP2024/074682

§ 371 Date: Feb. 27, 2026

(30) Foreign Application Priority Data
Sep. 7, 2023 (EP) 23306482.3
Sep. 15, 2023 (GB) 2314113.8

(51) Int. Cl. H04W 74/0808; H04W 48/08

(52) U.S. Cl. CPC H04W 74/0808; H04W 48/08

(57) ABSTRACT

A primary channel of an operating channel becomes busy due to interference or OBSS. An AP and a non-AP station agree on secondary channels, SCHs, that may be used for secondary channel access, SCA. SCA support and SCA capabilities are exchanged through management frames, for example during association of the non-AP station with the AP. Hence, in response to determining that the primary channel becomes busy, the two stations switch to a SCH and perform SCA on the SCH. Upon gaining access to the SCH, they exchange data or frames as SCA operation. Upon ending the SCA operation, they return to normal operation on the primary channel. The stations switch from one SCH to another one when the former is also busy. An order of SCHs to be considered is defined in the exchanged management frames.

### FIELD OF THE INVENTION

The present invention relates to wireless communications and more specifically to secondary channel access operation.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section. Furthermore, all embodiments are not necessarily intended to solve all or even any of the problems brought forward in this section.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks. The 802.11 family of standards adopted by the Institute of Electrical and Electronics Engineers (IEEE) provides a great number of mechanisms for wireless communications between stations.

Efficient medium usage within one operating channel having an operation bandwidth (up to 320 MHz in the latest 802.11 be D 4.0 standard, but may be wider in future amendments) has evolved along the evolution of the IEEE (RTM) 802.11 standards. For example, dynamic bandwidth signalling feature was introduced in the IEEE 802.11ac amendment, preamble puncturing feature was introduced in the IEEE 802.11ax standard and further evolved in the IEEE 802.11be amendments.

An operating channel of 40, 80, 160 or 320 MHz bandwidth (or even more in the future) is usually made of a primary channel and one or more secondary channels (each channel being 20 MHz or a multiple thereof). The primary channel is used for signalling (including channel access procedure such as the contention-based channel access method called Enhanced Distributed Channel Access-EDCA) and backwards compatibility while the secondary channels are only used when sending data at full speed. All of the known features for efficient medium usage assumes that the primary channel is idle. If the primary channel is busy for instance due to interference, stations are not allowed to send any frame even if the secondary channels are idle. Some techniques have been proposed to change the operation bandwidth to a subpart thereof (e.g., from 80 MHz to 40 MHz) when the primary channel is idle, with the hope that the new operating channel does not suffer from interference. This is however a complex process, while it dramatically excludes the future use of the entire initial wider bandwidth in case the interference reduces or stops. The wireless medium thus remains inefficiently used.

### SUMMARY OF THE INVENTION

An aim of the invention is to improve the use of the medium within the operating channel. It is achieved by enabling secondary channel access (SCA) operation, i.e., operations on secondary channels (SCHs), even if the primary channel is busy. In this respect, the invention provides a method of communication in a wireless network comprising, at a station belonging to a Basic Service Set, BSS, managed by an access point, AP, station:
in response to determining that a primary channel of an operating channel of the BSS is busy, performing channel access on a secondary channel of the operating channel.

The channel access on the secondary channel can be referred to as a non-primary channel access, NPCA, or a secondary channel access, SCA.

The station may be the AP station itself to e.g., transmit data to its associated stations over the secondary channel, while its primary channel is busy. Alternatively, it may be a non-AP station that uses the secondary channel. Of course, multiple stations of the BSS can simultaneously switch to the secondary channel to perform the channel access procedure when the primary channel is busy, and then communicate over the secondary channel. The AP station may access the secondary channel while the primary channel is busy and then send data to a (or more) non-AP station of its BSS. Reversely, a non-AP station may access the secondary channel using SCA and then send data to the AP station over the secondary channel.

The channel access procedure on the secondary channel is preferably a contention-based one, such as EDCA.

Optional features are defined below with reference to methods, while they can be transposed into device features.

In some embodiments, the secondary channel is previously agreed with another station of the BSS. A non-AP station agrees with the AP station with which it desires to communicate, and reversely the AP station may agree with each non-AP station with which it desires to communicate. In that case, upon accessing the secondary channel through channel access on the secondary channel (SCA), the station exchanges frames with the other station over the accessed secondary channel, wherein the station and the other station include the AP station and a non-AP station of the BSS.

In a variant, a non-AP station may agree with the AP station about the secondary channel for the BSS and then may communicate with another non-AP station of the BSS using the secondary channel agreed for the BSS. In that case, the other station is the AP station (with which the secondary channel is agreed) and, upon accessing the secondary channel through SCA, the station exchanges frames with another non-AP station over the accessed secondary channel.

In specific embodiments, the station and the other station exchange one or more management frames to agree on the secondary channel. In particular, the exchange of management frames may take place during an association procedure between the two stations. No additional procedure is therefore required.

In specific embodiments, the management frames include one or more of the following frames:
a beacon frame from the AP station to advertise one or more secondary channels eligible for channel access (SCA). The non-AP station may use the signalled secondary channels for channel access or may try to negotiate them,
a probe request frame to the AP station for the other station to advertise one or more secondary channels eligible for channel access. The signalled secondary channels are preferable those signalled in the beacon frame or a subset (selection) thereof meaning a negotiation is conducted,
a probe response frame from the AP station to advertise one or more secondary channels eligible for channel access. The AP station may here either accept the channels proposed by the non-AP station through the probe request frame, or provide a counterproposal,
an association or reassociation request frame to the AP station for the other station to advertise one or more secondary channels eligible for channel access. As for the probe request frame, this may be to signal another proposed selection of secondary channels, in particular a selection from those provided in the probe response frame or the beacon frame,
an association or reassociation response frame from the AP station to advertise one or more secondary channels eligible for channel access. As for the probe response frame, the AP station may here either accept the channels proposed by the non-AP station by accepting the association, or provide a counterproposal while refusing the association. Of course, the AP station may also merely reject a requested association without providing a counterproposal, if the secondary channels proposed by the non-AP station are not acceptable.

More generally, these frames can include (SCA) support and/or capabilities of the transmitting station as explained below.

In some embodiments, the station may further transmit a frame including a (SCA) Control field to signal whether channel access on the secondary channel (SCA) is enabled or disabled at the station. In that way, the station may dynamically manage its SCA operation.

In some embodiments, the station is the AP station and, upon agreeing with a non-AP station on one or more secondary channels that form a subset of secondary channels eligible for channel access (SCA) signalled in a local register of the AP station, the AP station updates the local register to the subset in order to propose the subset of secondary channels to any other non-AP stations willing to join the BSS. As a result, all the non-AP stations joining the BSS use the same SCHs. These embodiments thus allow for the other non-AP STAs to align their SCHs for SCA with already associated non-AP STA.

In other embodiments where the station is a non-AP station, the method comprises receiving at least two frames from at least two respective AP stations managing respective BSSs, each frame including support information signalling support of the channel access on the secondary channel (SCA) by the respective AP station and capabilities information advertising secondary channel or channels eligible for channel access within the respective BSS in case of supported channel access on the secondary channel,
selecting one of the AP stations based on the received support and capabilities information, and
requesting association with the selected AP station.

The non-AP station can then select the AP station that best matches its own (SCA) capabilities. This contributes to improve use of the wireless medium since the non-AP station is more likely to efficiently use the SCH.

In other embodiments where the station is the AP station, the method comprises receiving a frame (e.g. probe request frame or association request frame) from a non-AP station, the frame including support information signalling support of the channel access on the secondary channel by the non-AP station and capabilities information advertising secondary channel or channels eligible for channel access by the non-AP station in case of supported channel access on the secondary channel,
deciding whether to accept or refuse association of the non-AP station based on the received support and capabilities information, and
transmitting, to the non-AP station, an association response frame according to the decided acceptance or refusal.

The AP station can then limit access to the BSS to only non-AP station that can efficiently use the SCH. This also contributes to improve use of the wireless medium.

In some embodiments regarding signalling, a frame exchanged between the station and another station of the BSS includes capabilities information advertising the secondary channel or channels eligible for channel access in case of supported channel access on the secondary channel, and optional support information signalling support of the channel access on the secondary channel by the station transmitting the frame. The support and capabilities information can then be shared. Support may be implicitly inferred from the presence of the capabilities information in the frame.

In particular embodiments, the frame includes a single Information Element to signal both support information and capabilities information. However, in variants the frame may include a first Information Element to signal the support information and a second separate Information element to signal the capabilities information.

In other embodiments, the capabilities information includes a (Secondary Channel, SCH) bitmap that advertises which secondary channel or channels forming the operating channel are eligible for channel access. Such signalling format makes it possible to signal all the SCHs all at once. Each bit within the bitmap may correspond to each successive elementary (in particular 20 MHz) channel composing the operating channel, hence easing the signalling of which SCH is eligible or not for channel access (SCA). For example, eight bits may correspond to the eight 20 MHz channels forming a 160 MHz operating channel.

In variants, the capabilities information may include a (Secondary Channel, SCH) field that comprises an offset value defining a single secondary channel eligible for channel access within the operating channel. Various offset values may define the various positions of all the secondary channels within the operating channel, e.g. from the first (in terms of lower frequency) channel. These variants reduce signalling costs. They may be used in particular when a single SCH is to be signalled.

In other embodiments, the capabilities information includes a switching delay field that indicates a time needed by the transmitting station to switch from one secondary channel to another secondary channel to perform channel access. This helps the stations to switch to the same SCH in the same timing, hence to guarantee that the SCA operation are synchronous between the stations.

In yet other embodiments, the capabilities information signals a number of transmit and receive channels the transmitting station can simultaneously use during respectively transmitting and receiving operations. This allows to know how many SCHs can be expected in the SCA capabilities information.

In particular, the signalling of the number of transmit and receive channels may include one from amongst:
a first field defining a maximum number of transmit channels the transmitting station can simultaneously use during transmitting operations and a second separate field defining a maximum number of receive channels the transmitting station can simultaneously use during receiving operations, and
an (SCA) mode field carrying a single value that defines a number of transmit channels and a number of receive channels. As an example, a simple mode field is a one-bit field that takes a first value to signal a single transmit channel and a single receive channel, and takes a second value to signal multiple transmit channels and multiple receive channels. Of course, more complex mode field formats may be used to be able to signal more possible configurations of transmit and receive channels.

In some additional signalling embodiments, the capabilities information further includes an (SCH) sequence field advertising about another set of one or more secondary channels eligible for channel access. It is additional to the secondary channels defined in the (SCH) bitmap or field introduced above. This additional field offers other SCH options for the station willing to perform SCA operations, in case some SCHs are also busy in the same way as the primary channel is.

In these additional embodiments, the sequence field may include:
one or more (SCH) bitmaps, each advertising a new set of secondary channels of the operating channel to be considered for channel access, or
one or more successive (SCH) fields that define one or more successive other secondary channels of the operating channel to be considered for channel access, or
a Start index field to signal a starting one of the secondary channels of the operating channel as a new secondary channel to be considered for channel access, a Direction field to signal in which direction traversing, within the operating channel from the starting secondary channel, the secondary channels to be considered for channel access, and an optional Skip Channel field to define one or more of the secondary channels to skip when traversing for the first time the secondary channels of the operating channel for consideration for channel access.

In other additional signalling embodiments, the capabilities information further includes an (SCH) priority field providing a priority order of the secondary channels advertised in the (SCH) bitmap to perform channel access on the secondary channel. More efficient SCHs can therefore be prioritized, with a view of improving the use of the wireless medium.

In these additional embodiments, the priority field may include:
one or more (SCH) bitmaps, each associated with a priority level and each signalling which of the secondary channels benefit from the associated priority level for consideration for channel access, or
one or more successive (SCH) fields, each signalling one of the secondary channels, the order of the fields defining a priority order of the respective secondary channels for consideration for channel access, or
a Start index field to signal a starting one of the secondary channels to which a starting priority level is assigned, a Direction field to signal in which direction traversing, within the bitmap from the starting secondary channel, the secondary channels according to an increasing or decreasing priority order from the starting priority level, and an optional Skip Channel field to define one or more of the secondary channels to skip when traversing for the first time the secondary channels of the bitmap to assign them the increasing or decreasing priority levels.

In some embodiments, the station may, in response to determining that the secondary channel is busy, switch to another secondary channel to perform channel access. This may be repeated from one secondary channel to another one until an idle secondary channel is found. The order of the secondary channels eligible for channel access may be predefined in the capabilities information as defined above.

In other embodiments, the station may perform simultaneously multiple channel accesses on multiple secondary channels of the operating channel when the primary channel is determined as being busy. This intends to increase chances to gain access to a channel. In practice, the station may transmit data over the secondary channel on which channel access is first obtained.

In yet other embodiments, the station may set a network allocation vector, NAV, mirroring an occupation of the primary channel, and terminate (SCA) operation on the secondary channel upon the NAV expiring, to switch back to the primary channel to perform channel access. By returning to normal operation (on the primary channel) as early as possible, the entire operating channel can again be used for communication. This improves communication efficiency over the wireless network.

Correlatively, the invention also provides a wireless communication device comprising at least one microprocessor configured for carrying out the steps of any of the above methods. The wireless communication device may be either of an AP station and a non-AP station.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Some embodiments of the present invention are illustrated by way of example, and not by way of limitation, in the figures of the accompanying drawings, in which like reference numerals refer to similar elements and in which:

FIG. 1 illustrates an example of a network system in which some embodiments of the invention may be implemented;

FIG. 1a illustrates 802.11ac channel allocation that supports operating channels of 20 MHz, 40 MHz, 80 MHz or 160 MHZ;

FIG. 2 illustrates, using a flowchart, exemplary steps performed at stations for SCA operation, according to some embodiments of the invention;

FIGS. 3a and 3b illustrates exemplary information element formats exchanged within a SCA setup procedure, according to some embodiments of the invention;

FIGS. 4a to 4e illustrate exemplary SCA capabilities field formats exchanged within a SCA setup procedure, according to some embodiments of the invention;

FIGS. 5a to 5e illustrate exemplary of SCH sequence and/or SCH priority field formats of FIGS. 4d and 4e, exchanged within a SCA setup procedure, according to some embodiments of the invention;

FIGS. 6a and 6b illustrate uses of the SCH sequence and/or SCH priority field format of FIG. 5e, according to some embodiments of the invention;

FIG. 7 illustrates, using a flowchart, an exemplary management frames exchange sequence allowing the two stations to share and negotiate the candidate SCHs for SCA operation, according to some embodiments of the invention;

FIG. 8 illustrates, using a flowchart, another exemplary management frames exchange sequence allowing a non-AP STA to select one AP for association, according to some embodiments of the invention;

FIG. 9 illustrates, using a flowchart, exemplary steps to operate a part of SCA operation on both the AP and the non-AP STA, according to some embodiments of the invention;

FIG. 10 illustrates, using a flowchart, exemplary steps to operate another part of SCA operation at the AP, according to some embodiments of the invention;

FIG. 11 illustrates, using a flowchart, exemplary steps to operate another part of SCA operation at the non-AP STA, according to some embodiments of the invention;

FIG. 12 illustrates, using a flowchart, exemplary steps to operate another part of SCA operation at both the AP and the non-AP STA, according to some embodiments of the invention;

FIGS. 13a and 13b illustrate, using flowcharts, exemplary steps of SCA management at both the AP and the non-AP STA, according to some embodiments of the invention;

FIGS. 14a and 14b illustrate exemplary SCA Control field formats transmitted within the MAC header of a Data frame or within an Action frame, according to some embodiments of the invention; and

FIG. 15 illustrates an example of hardware configuration of both AP and non-AP STA, according to some embodiments of the invention.

### DESCRIPTION OF SOME EMBODIMENTS

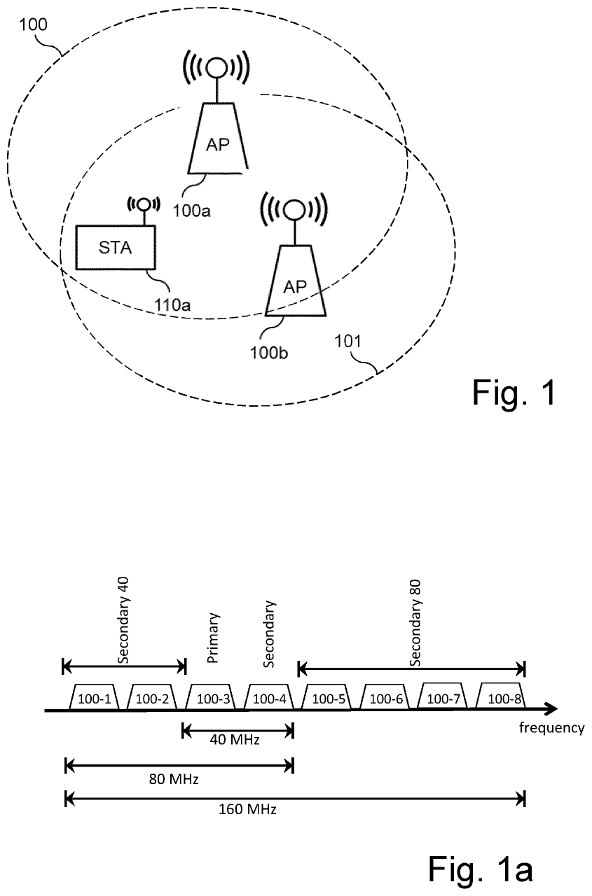

FIG. 1 illustrates an example of a network system in which some embodiments of the invention may be implemented.

For the sake of illustration, FIG. 1 represents two 802.11 network (i.e., a Wi-Fi network—RTM) systems 100 and 101. 802.11 network system 100 consists of two wireless devices: an access point station (AP) 100a and a non-AP station (non-AP STA) 110a. Of course, the number of non-AP STAs may be different from one. The AP manages the set of non-AP STAs that together organize their accesses to the wireless medium, known as “operating channel”, for communication purposes. The stations (including the AP) form a service set, here below referred to as basic service set, BSS (although other terminology can be used). A same physical station acting as an access point may manage two or more BSS (and thus corresponding WLANs): each BSS is thus uniquely identified by a specific basic service set identification (BSSID) and managed by a separate virtual AP implemented in the physical AP

AP 100a provides wireless connections between stations of the BSS (including non-AP STA 110a and AP 100a) and provide an access to a wider network, such as the Internet. The connection of a non-AP STA 110a to AP 100a may be performed by a standardized process called association.

Once a non-AP STA is associated with the AP, the non-AP STA can access the operating channel, send data over it to other stations of the BSS or to the wider network via the AP and receive data from other stations or from the wider network through the AP. The 802.11 family of standards define various media access control (MAC) mechanisms to drive access to the wireless medium.

FIG. 1a illustrates 802.11ac channel allocation that supports operating channels of 20 MHz, 40 MHz, 80 MHz or 160 MHz. 802.11 be D 4.0 has further introduced an operating channel of 320 MHz. Future standards may even propose wider operating channels.

An elementary channel 100-1 to 100-8 is 20 MHZ wide. The IEEE 802.11 family introduces support of a restricted number of predefined subsets of 20 MHz channels to form predefined operating channel configurations that are available for the BSSs. The predefined subsets in 802.11ac are shown in FIG. 1a and correspond to 20 MHz, 40 MHz, 80 MHz, and 160 MHz channel bandwidths, each grouping 2″ elementary 20 MHz channels. Indeed, the 20 MHz component channels 100-1 to 100-8 are concatenated to form wider operating channels. As shown the elementary 20 MHz channels of the predefined subsets are contiguous. Optionally a predefined subset may be formed by elementary channels that are not all contiguous, e.g., a 160 MHz operating channel may be made of two separate 80 MHz channels. The elementary 20 MHz channels for the operating channel are selected from the 20 MHz channels available in the wireless band considered. The number of 20 MHz channels per band varies between the 2.4 GHz, 5 GHZ and 6 GHz bands.

The AP elects one of the elementary 20 MHz channel of the operating channel as being the “primary channel” common to all the stations of the BSS. The primary channel is used for signalling (including channel access procedure) and backwards compatibility. Hence, a station (including the AP) is granted a transmission opportunity (TXOP) through the enhanced distributed channel access (EDCA) procedure performed on the primary channel 100-3. The other elementary 20 MHz channels of the operating channel are referred to as “secondary channels”.

802.11 network system 101 is another, but similar, 802.11 network system comprising one wireless device: AP 100b. Of course, it may contain one or more non-AP STAs. System 101 operates on the same operating channel as BSS 100.

Non-AP STA 110a is within the range of both APs 100a and 100b. AP 100a is within the range of AP 100b. As AP 100a and AP 100b use the same operating channel, they are considered to be “overlapping”, i.e., they have no connection to each other but they interfere with each other. It is said they are in the relationship of OBSS (Overlapping Basic Service Set).

APs 100a and 100b may comprise, be implemented as, or known as a Node B, Radio Network Controller (RNC), evolved Node B (eNB), 5G Next generation base station (gNB), Base Station Controller (BSC), Base Transceiver Station (BTS), Base Station (BS), Transceiver Function (TF), Radio Router, Radio Transceiver, Basic Service Set (BSS), Extended Service Set (ESS), Radio Base Station (RBS), or some other terminology. It can be a standalone product or it may be integrated in a device, for instance in a broadband remote access server (BRAS).

Non-AP STA 110a may comprise, be implemented as, or known as a subscriber station, a subscriber unit, a mobile station (MS), a remote station, a remote terminal, a user terminal (UT), a user agent, a user device, a user equipment (UE), a user station (STA), or some other terminology. In some implementations, a non-AP STA may be or may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or a smartphone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, non-AP station 110a may be a wireless node. Such a wireless node may provide, for example, connectivity for or to a network (e.g., a wide area network such as the Internet or a cellular network) via a wired or wireless communication link.

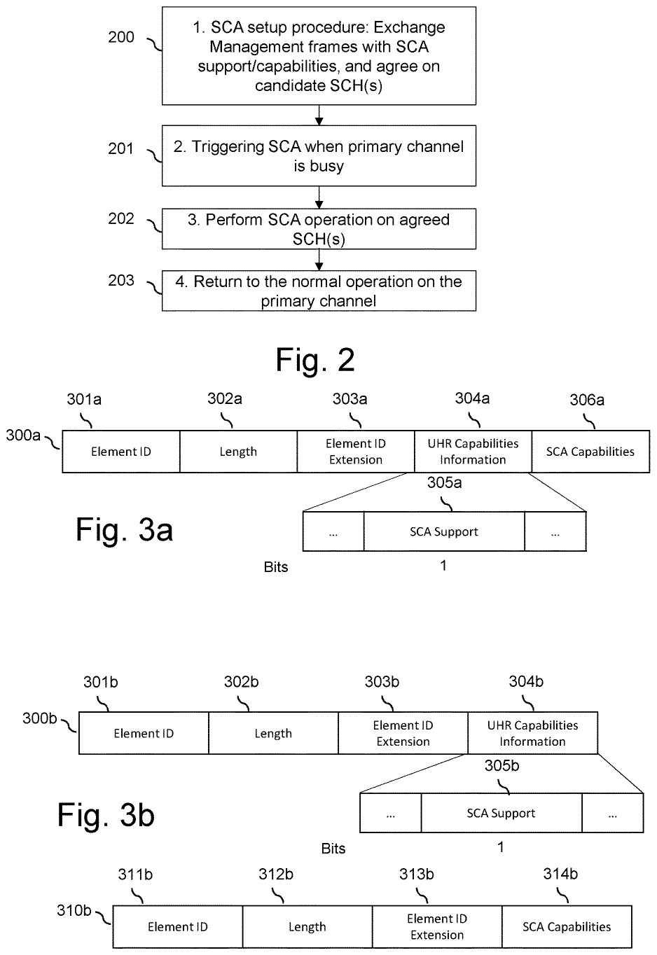

FIG. 2 illustrates, using a flowchart, exemplary steps performed at a station (including both AP and non-AP STA of the BSSs) for Secondary Channel Access (SCA) operation. The core idea of the proposed SCA operation is to switch the medium access procedure to one or more SCHs (Secondary Channels) that may be pre-agreed between the AP and the non-AP STAs, when the primary channel is detected as busy due to an interference (e.g., OBSS communication, non-Wi-Fi interference). Medium access procedure may be the same procedure as the legacy 802.11 devices conduct on its primary channel (e.g., EDCA) but not limited to it. Thus, AP and non-AP STA may agree on which SCH to use beforehand since they cannot communicate if they use different SCHs. FIG. 2 illustrates, using a flowchart, exemplary general steps of a communication method in which stations agree on the SCH to be used for SCA and then perform SCA operation.

At step 200, the station exchanges with another station one or more management frames to agree on the secondary channel to be used for SCA. In particular, such a frame exchanged between the stations may include SCA support information signalling support of the SCA by the station transmitting the frame and SCA capabilities information advertising the secondary channel or channels eligible for SCA in case of supported SCA. SCA support and SCA capabilities are described below.

The Management frames may include Beacon frames, Probe Response frames, (Re)Association Response frames for APs and (Re)Association Request frames for non-AP STAs. Hence, the exchange of management frames may take place during an association procedure between the two stations. They may also include other Management frames such as Action Frames, Probe Request frames, Authentication frames but not limited to these frames. Based on the exchanged SCA capabilities, the stations agree on candidate SCH(s) that includes at least one SCH. Step 200 is therefore a “SCA setup procedure”.

Various scenarios of SCA setup procedure may be contemplated as described below (e.g., with respect to FIG. 7), from an SCH imposed by the AP to a true negotiation of SCHs between the two stations (including multiple back and forth of frames containing proposals and counterproposals). The candidate SCH or SCHs are thus previously agreed between the two stations.

Next at step 201, the station determines when the primary channel of the operating channel becomes busy. Activity on the primary channel may be detected using CCA (Clear Channel Assessment) that includes both PD (Packet detection) and ED (Energy Detection). The primary channel thus becomes not accessible to the station. This triggers the station to operate SCA with the other station (peer station).

At step 202 in response to the positive determining of step 201, the station perform SCA on at least one of the agreed candidate SCH(s) determined at step 200. Of course, the peer station may operate in the same way at its side.

SCA allows the station to gain access to the wireless medium and then to perform data communication over the SCH or SCHs with the peer station. This forms SCA operation. Of course, any other use of the gained SCH may be contemplated within the SCA operation.

At step 203, after having performed the SCA operation, the station returns to conventional operation that uses the primary channel for the medium access procedure.

SCA support information and SCA capabilities information of both stations are advertised or signalled in the management frames using Information Elements, IEs. In some embodiments, as illustrated below through FIG. 3a for instance, a single IE may be used to signal both SCA support information and SCA capabilities information. In variants illustrated by FIG. 3b, a first IE is used to signal the SCA support information while a second separate IE is used to signal the SCA capabilities information.

All of the name of the elements and/or fields shown in FIGS. 3, 4 and 5 are merely examples, meaning alternative names can also be used in variants. In the same way, the order of the fields as shown is for illustrative purposes only, meaning any other order can be used.

FIG. 3 illustrates examples of information element formats exchanged within a SCA setup procedure. As described, on step 200, STAs indicates its own SCA support and SCA capabilities with the information included in the Management frames.

FIG. 3a illustrates a first example of SCA support and SCA capabilities indication conveyed in the same IE, referred to as UHR Capabilities element 300a.

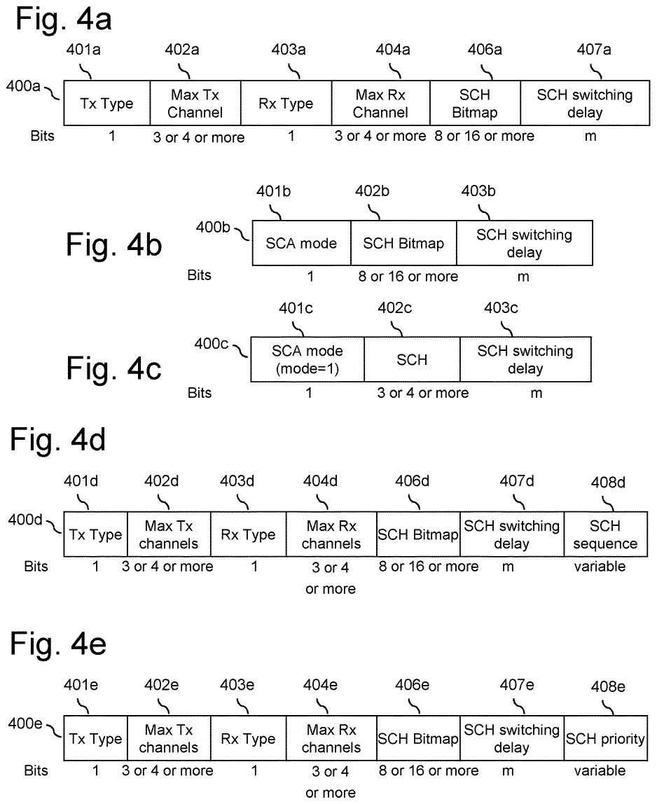

Element ID field 301a and Element ID Extension field 303a are used to identify the UHR Capabilities element. To do so, Element ID field 301a is set to value 255 and Element ID Extension field 303a is set to a value not yet used in the latest 802.11 be D 4.0 amendment, such as any of 136-255. Length field 302a indicates the number of octets in the IE 300a excluding Element ID and Length fields. UHR Capabilities Information field 304a may include various capabilities information (e.g. those defined in the 802.11bn amendment) together with SCA Support field 305a used to signal whether the transmitting station supports SCA. SCA Support field 305a is at least one bit long. Value 0 may indicate that the station does not support SCA operation, while value bit 1 may indicate it does support SCA operation. When SCA Support field indicates support of SCA operation, additional SCA Capabilities field 306a may be present (SCA Capabilities field may thus be omitted when SCA Support field indicates SCA is not supported). SCA Capabilities field 306a is used to advertising candidate SCH or SCHs, i.e., secondary channel or channels eligible for SCA. Various signalling formats of the SCA capabilities are proposed below with reference to FIG. 4.

FIG. 3b illustrates second example of SCA support and SCA capabilities indication conveyed in separate IEs. In this example, UHR Capabilities element 300b is similar to IE 300a, hence it indicates SCA support (in SCA Support field 305b), except that it does not include SCA Capabilities field. Fields 301b~305b are identical to fields 301a~305b respectively. Another independent IE, SCA Capabilities element 310b, conveys the SCA capabilities through dedicated SCA Capabilities field 314b, similar to field 306a. When SCA Support field indicates the support of SCA operation, STA additionally includes SCA Capabilities element 310b in the Management frames. Otherwise, SCA Capabilities element 310b is not included. Fields 311b~313b are identical to fields 301b~303b respectively except that Element ID Extension 313b has a different value (from 136-255) to distinguish from UHR Capabilities element 300b.

In some embodiments, SCA Support field 305b is optional. Indeed, one alternate way to indicate SCA support with fewer bits (i.e., without field 305b) is to use the presence of SCA capabilities element 310b in the frame. If STA includes SCA capabilities element 310b in its Management frame, this indicates SCA is supported. On the contrary, if STA does not include SCA capabilities element 310b in its Management frame, this indicates SCA is not supported. In this case, STA may include UHR Capabilities element 300b to indicate other UHR Capabilities in its Management frame but without including SCA Support field 305b to save bits.

FIG. 4 illustrates exemplary SCA Capabilities field formats exchanged within a SCA setup procedure. These are examples of SCA Capabilities field 306a or 314b shown in FIG. 3.

Since SCA operation may depend on both transmitter capability and receiver capability, it is worth indicating this information in the SCA Capabilities field. It is thus contemplated that the SCA capabilities information signals a number of transmit and receive channels the transmitting station can simultaneously use during respectively transmitting and receiving operations. Some embodiments as exemplified through FIG. 4a provide a detailed advertising of those transmitter and receiver capabilities, while other embodiments as exemplified through FIGS. 4b and 4c provide lightened advertising of those capabilities to save signalling bits. Indeed, the number of supported simultaneous transmitter (or receiver) channels may inform about the number of candidate SCHs. One of the relevant transmitter capabilities may be the maximum number of transmit (Tx) channels that the station can simultaneously use for transmission procedure. Transmission procedure may be any of the transmission procedures existing in the 802.11 specification such as the CCA procedure, the backoff procedure and/or the packet transmission based on supported PHY/MAC specifications. Similarly, one of the relevant receiver capabilities may be the maximum number of receive (Rx) channels that the station can simultaneously use for reception procedure. Reception procedure may be any of the reception procedures existing in the 802.11 specification such as the preamble detection, the preamble decoding and the packet decoding.

Candidate SCH or SCHs are preferably advertised using a bitmap as exemplified through FIGS. 4a and 4b. In that case, the SCA capabilities information includes a SCH bitmap that advertises which secondary channel or channels forming the operating channel are eligible for SCA. In variants where it is known that a single candidate SCH is provided, a SCH field having less bits can be used, as exemplified through FIG. 4c. In this example, the SCA capabilities information includes a SCH field that comprises an offset value defining a single secondary channel eligible for SCA within the operating channel.

Back to the SCH bitmap, each bit therein corresponds to one elementary 20 MHz channel forming the operating channel of the BSS. Hence, SCH Bitmap may have eight bits to indicate eight 20 MHz channels for 5 GHz/6 GHz operation till 160 MHz operating channel, or may have sixteen bits to indicate sixteen 20 MHz channels for 6 GHz band operation for 320 MHz and may have more bits (e.g., 32 bits for 640 MHz) for future wider bandwidth operation. The mapping of each bit in the SCH Bitmap to each 20 MHz channel can be known based on the operating bandwidth of the BSS indicated by the Operation element of each PHY/MAC specification provide by the AP (e.g., HT/VHT/HE/EHT/UHR Operation element). For example, in EHT 320 MHz case, the AP transmits a Beacon frame that includes EHT Operation element. EHT Operation element includes EHT Operation information field that includes Control, CCFS0 and CCFS1 field. Control field includes Channel Width field. Channel Width field indicates the bandwidth of the operating channel for the BSS activated on the AP with the following values 0:20 MHz, 1:40 MHz, 2:80 MHz, 3:160 MHz, 4:320 MHz. In this example, 4 is set to indicate a 320 MHz operating channel. CCFS 1 indicates the channel center frequency index of the 320 MHz. For example, 63 indicates that Channel 63 is used as center frequency and that the 320 MHz bandwidth is allocated from Channel 33 (from 6,105 MHz) to channel 93 (to 6,425 MHz). With this example, each bit of SCH Bitmap (consisting of 16 bits) corresponds to one 20 MHz channel starting from 33 till 93 e.g., bit 0 matches to Channel 33 (0:33), bit 1 matches to Channel 37 (1:37), and so on (1:37, 2:41, 3:45, . . . 15:93). All other mapping for 40 MHz, 80 MHz and 160 MHz can be done by parsing the Operation elements as well. In addition, the primary channel of the operating channel can be identified as well using HT Operation element for 2.4 GHz and 5 GHz band operation and HE Operation element for 6 GHz band operation. All these examples may extend to a wider bandwidth that may be available in future 802.11 amendments such as 640 MHz and more. In such a case, UHR Operation element or further extended Operation element may also be available to handle the SCH Bitmap mapping.

One can recognize that the bit number in the above mapping can be used as an offset (from the starting channel, here Channel 33) to identify one of the 20 MHz channel. The offset value may thus be used to fill in the SCH field, hence defining the single secondary channel eligible for SCA in the variants mentioned above.

As shown in all the variants presented in FIG. 4, a SCA switching delay indicating a time or duration needed by the transmitting station to switch from one SCH to another SCH to perform SCA may be optionally provided. To that end, the SCA capabilities information may include an SCH switching delay field conveying such delay. Since the duration may differ from one station to the other, they have to notify it to their peer station for the case where SCA becomes active at the peer side. SCA switching delay field may consist of m bits, wherein the possible field values correspond to respective predefined switching delay times. For example, SCA switching delay may have 3 bits and each field value from 0 to 7 may have its pre-defined time such as 0:0 μs, 1:16 μs, 2:32 μs, 3:64 μs, . . . 7:1,024 μs. Bit size and each matching between a field value and a switching delay time are not limited to this example and may vary.

FIG. 4a illustrates a first example of SCA Capabilities field 400a. The detailed advertising of the transmitter and receiver capabilities includes Tx Type field 401a, Max Tx Channel 402a, Rx Type field 403a and Max Rx Channel 404a. Tx Type field 401a and Rx Type field 403a indicates the type of transmitter/receiver: for example, value 0 in either field indicates that only one channel is available and value 1 indicates that multiple channels are available simultaneously. Max Tx Channel 402a and Max Rx Channel 404a indicates the maximum number of simultaneously available channels. Both two fields may be 3-bit long to signal one to eight 20 MHz channels support for 2.4 GHz/5 GHz or 4-bit long to signal one to sixteen 20 MHz channels or more for future wider bandwidths. The two fields 402a, 404a may be omitted when the corresponding Tx/Rx Type field 401a/403a signals only one channel available. SCH Bitmap 406a and SCH switching delay field 407a may be included as explained above. The signalling format of FIG. 4a advantageously provides richer information to configure more flexible and detail configurations.

FIG. 4b illustrates a second example of SCA Capabilities field 400b. The lightened advertising of the transmitter and receiver capabilities includes an SCA mode field 401b carrying a single value that defines a number of transmit channels and a number of receive channels. SCA mode field 401b uses fewer bits than fields 401a to 404a. SCA mode field 401b may be one-bit long, two-bit long or more, depending on the number of combinations of number of Tx channels and number of Rx channels to code. For example, value 0 in a one-bit field may mean multiple simultaneous channels are supported for both Tx and Rx, while value 1 may mean only one channel is supported simultaneously for both Tx and Rx. A field encoded over more than one bit may be used to code more complex capabilities, e.g. a value may code multiple simultaneous channels for Tx but only one for Rx, another value may code multiple simultaneous channels for Rx but only one for Tx. Other values may indicate specific numbers of simultaneous channels (e.g., 2 or 3 in either Tx or Rx or both). SCH Bitmap 402b and SCH switching delay 403b are similar to fields 406a and 407a described above. In some embodiments, the number of bits that is shown as high (value 1) inside SCH Bitmap 402b indicates the lower one between Max Tx Channel 402a and Max Rx Channel 404a.

FIG. 4c illustrates a third example of SCA Capabilities field 400c. It is still based on the lightened advertising of the transmitter and receiver capabilities as shown in FIG. 4b (hence using SCA mode field). The proposed signalling is a special version of the signalling format of FIG. 4b when SCA mode field 401c is 1. Indeed, in this case, since only one SCH is available, SCH Bitmap field can be replaced by a mere SCH field that indicates the specific one channel. SCH field 402c conveys for instance an offset as mentioned above, i.e., an offset (in terms of 20 MHz channels) from the starting 20 MHz channel (i.e., having the lowest frequency). SCH field 402c may be 3-bit long to signal one from eight 20 MHz channels, 4-bit long to signal one from sixteen 20 MHz channels, or longer to signal more 20 MHz channels for future wider bandwidth. For example, in case of 320 Mhz operating channel with Channel 63 as the center frequency (meaning Channel 33 is the starting 20 MHz channel), the following offsets starting from Channel 33 can be used: 0 to indicate Channel 33 (0:33), 1 to indicate Channel 37 (1:37), and so on (2:41, 3:45, . . . 15:93). Fields 401c and 403c have an identical usage as 401b and 403b.

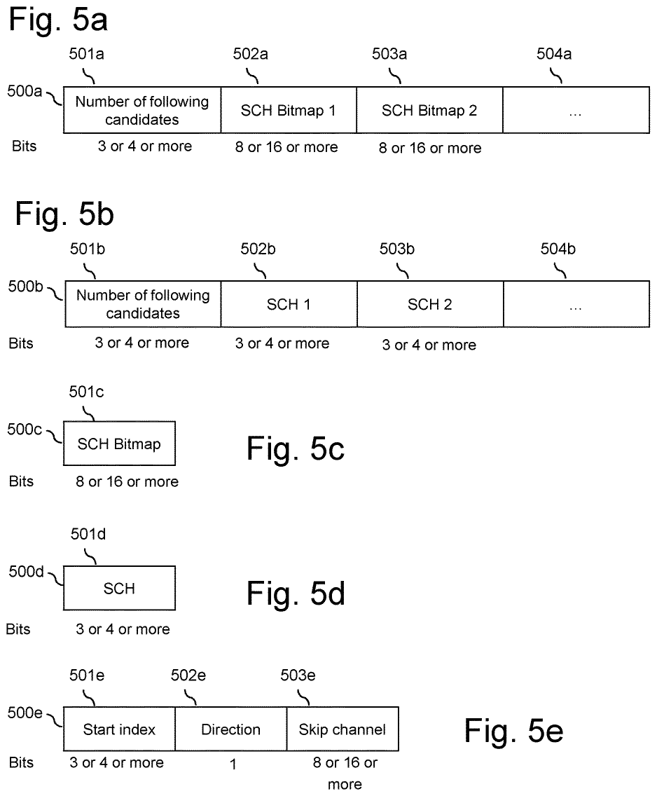

FIG. 4d illustrates a fourth example of SCA Capabilities field 400d having an extended format to further include an SCH sequence field advertising about another set of one or more secondary channels eligible for SCA. Fields 401d~407d have identical usage as fields 401a~407a respectively. SCH sequence field 408d is added in this example to show a further sequence of SCH(s). The further sequence provides another SCH(s) to which switching, when all the SCH(s) initially indicated in SCH bitmap 406d are also detected as busy due to interference. A description of SCH sequence field 408d is provided below with reference to FIG. 5. Although the fourth example is based on the signalling format of FIG. 4a, SCH sequence field 408d may alternatively be added to the signalling format of FIG. 4b, FIG. 4c or FIG. 4e now described.

FIG. 4e illustrates a fifth example of SCA Capabilities field 400e having an extended format to further includes an SCH priority field providing a priority order of the secondary channels advertised in the SCH bitmap to perform SCA. Fields 401e~407e have identical usage as fields 401a~407a respectively. SCH priority field 408e is added in this example to define which priority to apply between the SCHs indicated in SCH bitmap 406e, in particular when SCH bitmap 406b indicates two or more SCHs. The transmitting station may thus define a preference order for the SCHs to be successively considered for SCA. For example, one of the SCHs may have less interference than the other and thus may be prioritized. To that end, SCH priority field 408e is used to indicate the relative priorities of the SCHs. A description of SCH priority field 408e is provided below with reference to FIG. 5. Although the fifth example is based on the signalling format of FIG. 4a, SCH priority field 408e may be added to the signalling format of FIG. 4b or FIG. 4d.

FIG. 5 illustrates various examples of SCH sequence and/or SCH priority field formats exchanged within a SCA setup procedure. Both SCH sequence and SCH priority field formats are independent and the formats may be identical but may also be different.

FIG. 5a illustrates a first example of SCA sequence and/or SCA priority field 500a. In this example, field 500a includes one or more SCH bitmaps, the meaning of which depends on their usage (SCH sequence or SCH priority). For SCH sequence usage, each SCH bitmap advertises a new set of secondary channels of the operating channel to be considered for SCA, while for SCH priority usage, each SCH bitmap is associated with a priority level and signals which of the secondary channels (defined in main SCH Bitmap 406a, 402b, 406d, 406e) benefit from the associated priority level for consideration for SCA. Number of following candidates field 501a indicates the number of following SCH Bitmap fields. It can be 3-bit long to signal up to eight SCH Bitmap fields or 4-bit long to signal up to sixteen SCH Bitmap fields, or even longer to signal more SCH Bitmap fields. Each SCH Bitmap 502a, 503a, 504a may be 8-bit long to signal up to eight 20 MHz channels for 5 GHz/6 GHz operation till 160 MHz or 16-bit long to signal up to sixteen 20 MHz channels for 6 GHz band operation for 320 MHz or even longer to signal more channels (e.g., 32 bits for 640 MHz) for future wider bandwidth operation.

For SCA sequence usage, each SCH Bitmap field indicates the next set of candidate SCH(s). If the first set of SCH(s) indicated in SCH Bitmap field 406a/402b/406d/406e or SCH field 402c shown in FIG. 4 are all not available (i.e., busy), the next SCH(s) can be indicated here in the shown order. For SCA priority usage, each SCA Bitmap field corresponds to a priority level (e.g., according to their order within field 500a) and indicates the corresponding SCH(s) benefiting from the corresponding priority level by setting the corresponding bit to high. For example, in case SCH Bitmap field 408e is set to ‘00101110’ indicating that four SCHs are supported, SCH Bitmap 1 field 502a defining the highest priority level may be set to ‘00100010’ to indicate the 1^{st} and 4^{th} SCHs have the highest priority. SCH Bitmap 2 field 503a defining the next priority level may be set to ‘00001000’ to indicate the 2^{nd} SCH has the second priority. SCH Bitmap 3 field defining the lowest priority level may be set to ‘00000100’ to indicate the 3^{rd} SCH has the lowest priority. Note that the last SCH Bitmap can be omitted since the remaining SCH or SCHs are obviously assigned the last priority.

FIG. 5b illustrates a second example of SCA sequence and/or SCA priority field 500b. In this example, field 500a includes one or more successive SCH fields, the meaning of which depends on their usage (SCH sequence or SCH priority). For SCH sequence usage, the one or more successive SCH fields define successive other SCHs of the operating channel to be considered for SCA, while for SCH priority usage, each of them signals one of the SCHs defined in main SCH Bitmap 406a/402b/406d/406e, and the order of the SCH fields in field 500b defines a priority order of the respective SCHs for consideration for SCA. SCH fields 502b, 503b and 504b are thus used instead of SCH Bitmap fields 502a, 503a and 504a of FIG. 5a, hence saving bits to represent the sequence or priority. Number of following candidates field 501b indicates the number of following SCH fields. It can be 3-bit long to signal up to eight SCH fields or 4-bit long to signal up to sixteen SCH fields or even longer to signal more SCH fields. Each SCH field 502b, 503b and 504b may be 3-bit long to signal one from eight 20 MHz channels for 2.4 GHz/5 GHz or 4-bit long to signal one from sixteen 20 MHz channels for 6 GHz or even longer to signal one from more channels in future wider operating channels.

For SCA sequence usage, each SCH field indicates the next candidate of SCH to be considered for SCA, after all the SCH(s) indicated in main SCH Bitmap field 406a/402b/406d/406e or SCH field 402c have been considered as not available (i.e., busy). The order of the SCH fields may be used or in variants another order may be predefined. For SCA priority usage, the successive SCH fields define the priority order of the SCHs specified in each SCH fields. For example, in case main SCH Bitmap 406a/402b/406d/406e is set to ‘00101010’ indicating three SCHs are supported, SCH 1 field 502b may take value 2 to indicate the 1^{st} SCH has the highest priority, SCH 2 field 503b may take value 6 to indicate the 3^{rd} SCH has the second priority, and SCH 3 field 504b may take value 4 to indicate the 5^{th} SCH has the third priority. Note that the last SCH field can be omitted since the remaining SCH is obviously assigned the last priority.

By providing multiple SCH bitmaps or SCH fields, the signalling formats of FIGS. 5a and 5b advantageously allow multiple sequences of SCHs and/or multiple priority levels to be configured. In variants, shorter formats as shown in FIGS. 5c and 5d can be used to save bits, with a single SCH bitmap or SCH field to define a single additional sequence of SCHs or only two priority levels.

FIG. 5c illustrates a third example of SCA sequence and/or SCA priority field 500c. This is a simplified version of the example shown in FIG. 5a. This example includes only one SCH Bitmap field 501c to indicate one specific SCH Bitmap. The usage of SCH Bitmap field 501c is identical to 502a for both SCA sequence and SCA priority usage. Since only one SCH Bitmap is included in this example, Number of following candidates field 501a is no longer needed.

Similarly, FIG. 5d illustrates a fourth example of SCA sequence and/or SCA priority field 500d. This is a simplified version of the example shown in FIG. 5b. This example includes SCH field 501d to indicate one specific SCH. The usage of SCH field 501d is identical to 502b for both SCA sequence and SCA priority usage. Since only one SCH is included in this example, Number of following candidates field 501b is no longer needed.

FIG. 5e illustrates a fifth example of SCA sequence and/or SCA priority field 500e which defines a traversing or scanning procedure of the 20 MHz channels within the operating channel. In this example, Start index field 501e, Direction field 502e and optional Skip channel field 503e are introduced to indicate the SCA sequence and/or SCA priority with a different approach than the above four examples. The meaning of these fields depends on their usage (SCH sequence or SCH priority). For SCH sequence usage, Start index field 501e signals a starting one of the SCHs of the operating channel as a new SCH to be considered for SCA. Direction field 502e signals in which direction traversing, within the operating channel from the starting SCH, the secondary channels to be considered for SCA. Skip Channel field 503e defines one or more of the SCHs to skip when traversing for the first time the secondary channels of the operating channel for consideration for SCA. For SCH priority usage, Start index field 501e signals a starting one of the secondary channels to which a starting priority level is assigned, Direction field 502e signals in which direction traversing, within the SCH bitmap from the starting secondary channel, the secondary channels according to an increasing or decreasing priority order from the starting priority level, and Skip Channel field 503e defines one or more of the secondary channels to skip when traversing for the first time the secondary channels of the SCH bitmap to assign them the increasing or decreasing priority levels. Skip channel field 503e may be omitted to have a simpler format.

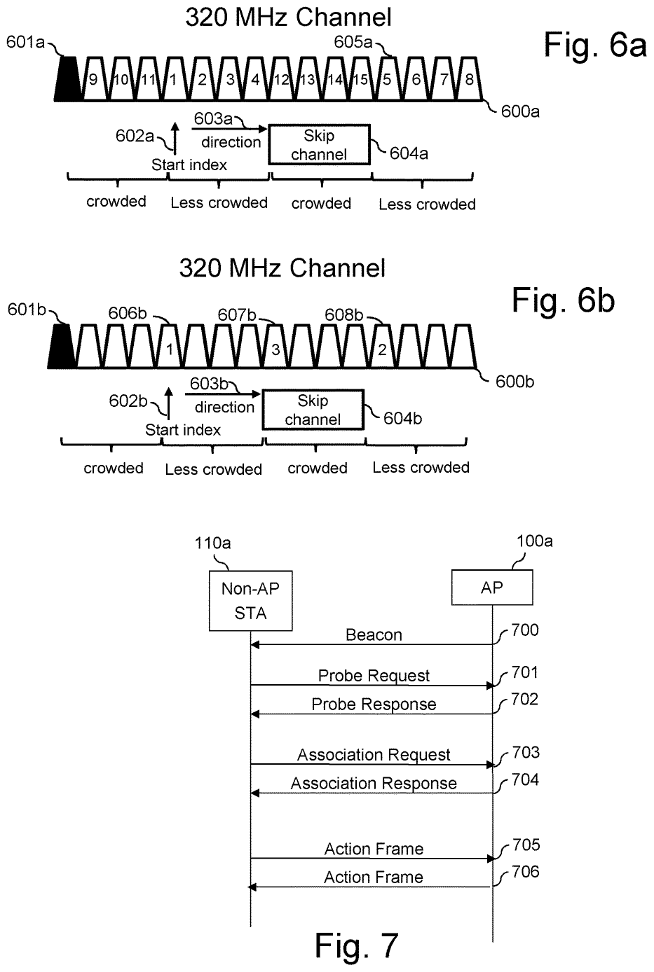

The usage of the signalling of FIG. 5e is now explained with reference to FIG. 6. 16 trapeziums shown in 600a, 600b corresponds to the sixteen 20 MHz channels forming the 320 MHz operating channel. The black trapeziums (601a and 601b) indicate the primary channel of the operating channel. Start index (602a and 602b), Direction (603a and 603b), Skip channel (604a and 604b) corresponds to the fields indicated in FIG. 5e respectively. Start index field indicates the index of the first 20 MHz channel to consider when traversing the 20 MHz channels forming the operating channel. In both examples illustrated in FIG. 6a and FIG. 6b, Start index indicates the 5^{th} 20 MHz channel counted from the minimum frequency side (i.e., left side). This can be indicated using value 4 in Start index field (0:1^{st} 20 MHz channel, 1:2^{nd} 20 MHz channel and so on). Direction field indicates in which direction (right or left) to perform the traversing of the next SCHs. In both examples illustrated in FIG. 6a and FIG. 6b, Direction field is set to indicate right direction. This can be indicated by value 0 in Direction field (i.e., value 1 for the left direction). Skip channel field indicates a set of SCHs to be skipped during the first traversing. In both examples illustrated in FIG. 6a and FIG. 6b, Skip channel field are set to 9^{th} to 12^{th} 20 MHz channels. This can be indicated by making the corresponding bit high in Skip channel field (set to ‘0000000011110000’ for this example). Skip channels can be non-contiguous with using bitmap expression. The scan thus performs one traversing from the starting SCH in the specified direction while dismissing the skipped SCHs, followed by a second traversing, still in the specified direction to consider the skipped SCHs.

A first illustration of field 500e for SCA sequence usage is now described with reference to FIG. 6a. Signalling format of FIG. 4c is used, meaning that one SCH is defined in SCH field 402c. It is assumed the indicated SCH corresponds to 20 MHz channel 605a. SCA sequence field 408d having Start index field 501e, Direction field 502e and Skip channel field 503e as defined above is added to SCA Capabilities field 400c. This results in having the SCHs being traverses in sequence following the numbers shown in each trapezium (600a) skipping the primary channel.

A second illustration of field 500e for SCA priority usage is now described with reference to FIG. 6a. Signalling format of FIG. 4b is used, meaning SCH Bitmap field 402b signals the available SCHs. It is assumed that all 20 MHz channels of the operating channel are available for SCA, meaning all the bits except the first one for primary channel are set to high (‘0111111111111111’). SCA priority field 408e having Start index field 501e, Direction field 502e and Skip channel field 503e as described above is added to SCA Capabilities field 400b. This results in having the SCHs being assigned the priority levels corresponding to the numbers shown in each trapezium (600a). Smaller number may indicate higher priority.

A third illustration of field 500e for SCA priority usage field is now described with reference to FIG. 6b. Signalling format of FIG. 4b is used, meaning SCH Bitmap field 402b signals the available SCHs. It is assumed that three 20 MHz channels of the operating channel are available for SCA as shown, that are indicated in SCH Bitmap field as follows: ‘0000100010001000’. SCA priority field 408e having Start index field 501e, Direction field 502e and Skip channel field 503e as described above is added to SCA Capabilities field 400b. This results in having the three SCHs being assigned the priority levels corresponding to the three numbers shown in the trapezium (600b). Smaller number may indicate higher priority, meaning the 5^{th} 20 MHz channel 606b is considered first as a candidate SCH, followed by the 13^{th} 20 MHz channel 608b and finally the 9^{th} 20 MHz channel 607b.

As mentioned above, with reference to FIG. 2, the SCA setup procedure includes an exchange of management frames.

FIG. 7 illustrates, using a flowchart, an exemplary management frames exchange sequence allowing the two stations to share and negotiate the candidate SCHs for SCA operation. The sequence takes place during the association procedure of a non-AP station with an AP, that is: AP 100a transmits Beacon 700 periodically (in general at every 100 msec interval); non-AP STA 110a transmits Probe Request frame 701 to scan APs in its vicinity; if AP 100a succeeds to receive Probe Request frame 701, it replies with Probe Response frame 702; if non-AP STA 110a decides to associate with AP 100a, it performs Authentication frame exchange (not illustrated) and then transmits Association Request frame 703 to AP 100a; if AP 100a agrees with the association requested by received Association Request frame 703, it replies with Association Response frame 704. The association of non-AP STA 110a with AP 100a is established when Association Response including a status code SUCCESS (0) is correctly received by non-AP STA 110a. After the association ends, AP 100a and non-AP STA 110a may exchange Action frames 705 and/or 706, access the operating channel and exchange data.

In embodiments of the invention, the SCA Support field and SCA capabilities field are exchanged between AP 100a and non-AP station 110a within any of these Management frames. Any formats of IEs as shown in FIG. 3, FIG. 4 and FIG. 5 can be used.

In some scenarios, AP 100a indicates its SCA support and capabilities (according to its own capabilities) into its Beacon frame 700 or Probe Response frame 702 or both. Non-AP STA 110a receives these Management frames and identifies AP 100a's SCA support and/or SCA capabilities by parsing the SCA support field 305a/b and/or SCA capabilities field 306a/314b. Then, non-AP STA 110a builds its own SCA support field and/or SCA capabilities field based on its own capabilities and AP 100a's SCA support and/or SCA capabilities. Since AP 100a and non-AP STA 110a have to agree on their SCH(s) for SCA, non-AP STA 110a either can directly agree with those proposed by AP 100a if they match its own SCA capabilities, or can negotiate by selecting SCH(s) from the ones proposed from AP 100a that match its own SCA capabilities. Selected SCH(s) is indicated at least within the SCA capabilities field 306a/314b included in Association Request frame 703 and optionally in Probe Request frame 701 to inform AP 100a about such non-AP STA's SCA capabilities.

AP 100a may include the same SCA capabilities as those transmitted by non-AP STA in Association Response frame 704 with Status Code SUCCESS (0) and optionally in Probe Response frame 702 to indicate non-AP STA 110a that the proposed SCA capabilities (hence SCHs) are acceptable. In variants, AP 100a may show acceptance of the proposed SCA capabilities by omitting SCA capabilities field in Association Response frame 704 with Status Code SUCCESS (0) and optionally in Probe Response frame 702. This reduces the frame size.

On the other hand, if AP 100a does not accept non-AP STA 110a's proposal, AP 100a may reject the association request by sending Association Response frame 704 with for example a new Status Code such as REJECTED_SCA_NOT_ACCEPTABLE (65534). This status code means the SCA capabilities proposed by non-AP STA 110a are not acceptable to AP 100a. Of course, any other value than 65534 (except those already defined in the latest 802.11 specifications) can be used as Status code rejecting the association based on the SCA capabilities. Non-AP STA 110a can therefore be aware of the detailed reason of the rejection, thanks to this status code. In some embodiments still rejecting the association, AP 100a can suggest a counterproposal of SCA capabilities to non-AP STA 110a, by including the SCA capabilities field in Association Response frame 704 with Status Code REJECTED_SCA_NOT_ACCEPTABLE (65534) or with another new Status Code such as REJECTED_SCA_WITH_NEW_PROPOSAL (65533). Of course, any other value than 65553 (except those already defined in the latest 802.11 specifications) can be used as Status code rejecting the association based on the SCA capabilities with a new proposal. Probe Response frame 702 may be also used by AP 100a to indicate a new proposal in case the proposal from non-AP STA 110a in Probe Request frame 701 is not acceptable. The new proposal (in either of Probe Response frame or Association Response frame) appears to be accepted if non-AP STA 110a includes it in the next Association Request frame it sends to AP 100a. This scenario shows that AP 100a may decide to accept or refuse an association based on SCA capabilities declared by the requesting non-AP STA. In other words, the AP receives a frame such as a probe request frame or an association request frame from a non-AP station, the frame including SCA support information signalling support of the SCA by the non-AP station and SCA capabilities information advertising SCH eligible for SCA by the non-AP station in case of supported SCA, and then decides whether to accept or refuse association of the non-AP station based on the received SCA support and capabilities information, and finally transmits, to the non-AP station, an association response frame according to the decided acceptance or refusal.

It is common that AP 100a has multiple non-AP STAs associated with it. To provide homogeneous behaviour within the BSS, AP 100a may decide to apply the same SCA capabilities to the non-AP STAs of its BSS. To that end, AP 100a may have a local register to store own SCA capabilities to share with the non-AP STAs. AP 100a may use the negotiation with any non-AP STA to update its SCA capabilities in the local register. In particular, upon agreeing with a non-AP station on one or more SCHs that form a subset of those indicated in the local register, the AP station may update the latter to the subset in order to propose the subset of secondary channels to any other non-AP stations willing to join the BSS. That means AP 100a updates its SCA capabilities field based on the agreed SCA capabilities among the associated non-AP STAs. For example, AP 100a may have three SCHs in its initial SCA capabilities when no non-AP STA is yet associated. Non-AP STA 110a willing to associate may have only one SCH in its initial SCA capabilities. SCH negotiation results in having non-AP STA 110a selecting one of the SCHs proposed by AP 100a during the association/negotiation. After having this agreement, AP 100a updates its SCA capabilities field to indicate only the selected one SCH instead of the three initial SCHs. This allows for the second or more non-AP STAs (not illustrated) to align their SCH for SCA with already associated non-AP STA 110a.

AP 100a may notify any updates of its SCA capabilities field (in its local register) to the already-associated non-AP STAs, as a critical update by following the BSS parameter critical update procedure defined in the IEEE 802.11be D4.0.

The agreement of the SCHs is done between AP and non-AP STA but the SCA operation can be done not only between AP and non-AP STA but also between two non-AP STAs that are both associated to the same AP. When two non-AP STAs conduct the SCA operation, they both use the SCHs agreed with the same AP during its association procedure.

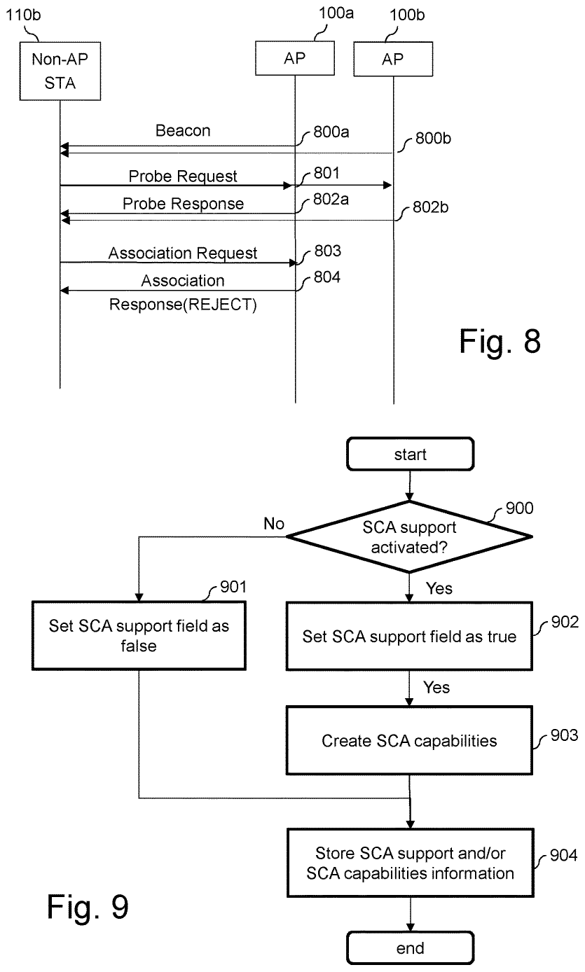

FIG. 8 illustrates, using a flowchart, another exemplary management frames exchange sequence allowing a non-AP STA to select one AP for association, based on SCA support and/or capabilities, in particular the candidate SCH or SCHs for SCA operation. This exemplary sequence of management frame exchange involves multiple APs (here two, APs 100a and 100b, but a higher number of APs may be involved), and also takes place during the association procedure of non-AP STA 110a.

In the scenario, non-AP STA 110a is within the range of both APs 100a and 100b. In this case, non-AP STA 110a can exchange management frames with both APs. Of course, more than two APs may be involved and exchange management frames with the same non-AP STA.

Beacon frames 800a and 800b sent by AP 100a and AP 100b respectively are received by non-AP STA 110a. Probe Request frame 801 transmitted by non-AP STA 110a is received by both APs 100a and 100b. Next, both APs 100a and 100b respond to non-AP STA 110a with Probe Response frames 802a and 802b respectively. Beacon frames can be omitted in some scenarios.

When non-AP STA 110a receives and parses Beacon frames 800a/b and/or Probe Response frames 802a/b, it becomes aware of the SCA support and/or SCA capabilities for each of APs 100a and 100b. Non-AP STA 110a may have a preference to associate with a particular AP given the SCA support and/or SCA capabilities of the APs available for association. As an example, only one AP supports SCA, or only one AP advertises a candidate SCH for SCA that is compatible with non-AP STA's SCA capabilities, or one AP has a higher number of candidate SCHs for SCA that are common to non-AP STA's SCA capabilities. Therefore, based on these SCA support and/or SCA capabilities of each AP station, non-AP STA 110a may decide to associate with AP 100a rather than with AP 100b.

In that case, the non-AP STA:
receives, from at least two AP stations, at least two management frames each including SCA support and/or SCA capabilities of the respective AP,
selects one of the APs based on the received SCA support and/or SCA capabilities from the APs, and
requests association to the selected AP. As shown in FIG. 8, non-AP STA 110a sends Association Request frame 803 to selected AP 100a.

Association Request frame 803 may include SCA support and/or SCA capabilities of non-AP STA 110a, hence providing knowledge of non-AP station's SCA support and/or SCA capabilities to selected AP 100a.

AP 100a receives and parses Probe Request frame 801 and/or Association Request frame 803 received from non-AP STA 110a and becomes aware of the SCA support and/or SCA capabilities of non-AP STA 110a. Based on the SCA support and/or SCA capabilities, AP 100a may decide to reject (or accept) the association by responding with an Association Response frame 804 having a status code meaning rejection. Again here, any AP station can use the SCA support and/or SCA capabilities of the requesting non-AP STA to accept or refuse an association request from this non-AP STA: the AP receives a frame such as a probe request frame or an association request frame from a non-AP station, the frame including SCA support and/or SCA capabilities information of the non-AP station, and then decides whether to accept or refuse association of the non-AP station based on the received SCA support and capabilities information, and finally transmits, to the non-AP station, an association response frame according to the decided acceptance or refusal.

Above status codes REJECTED_SCA_NOT_ACCEPTABLE (e.g., 65534) and REJECTED_SCA_WITH_NEW_PROPOSAL (e.g., 65533) in case of counterproposal can be used.

To have own SCA support information and SCA capabilities information available locally at any time for the stations, the latter have to prepare such information in advance when possible. FIGS. 9 to 11 illustrate some embodiments for preparing these pieces of information.

FIG. 9 illustrates, using a flowchart, exemplary steps to operate a part of SCA operation on both the AP and the non-AP STA. The steps may be performed for example when the station (i.e., AP or non-AP STA) is (re)activated (i.e., power on, reset, setting updated, etc.).

At step 900, the station determines whether it supports SCA or not. This support information for example may be stored in a memory and may be factory default setting and may be changed based on user's setting. If SCA support is activated, the process goes to step 902 where SCA support field in a volatile memory is set to true. Next, step 903 creates, still in volatile memory, own SCA capabilities depending on own device's capabilities, such as hardware capabilities. This may define which SCH or SCHs are available for SCA. Again, the SCA capabilities may be factory default setting and may be changed based on user's setting if they still satisfy the hardware capabilities. Those capabilities may further be changed depending on the wireless environment. For example, the station may know which SCH is more suitable for SCA operation knowing the interference or OBSS existence in its surroundings by any means. Using this information, the station may configure its SCA capabilities (e.g., SCH Bitmap field, SCH field, SCH sequence field, SCH priority field).

At step 900, if SCA support is not activated, the process goes to step 901 where SCA support field in the volatile memory is set to false.

At step 904, the SCA support information and/or the SCA capabilities information as created are stored in a non-volatile memory, such as a local register, so that the station can refer to them in a later process.

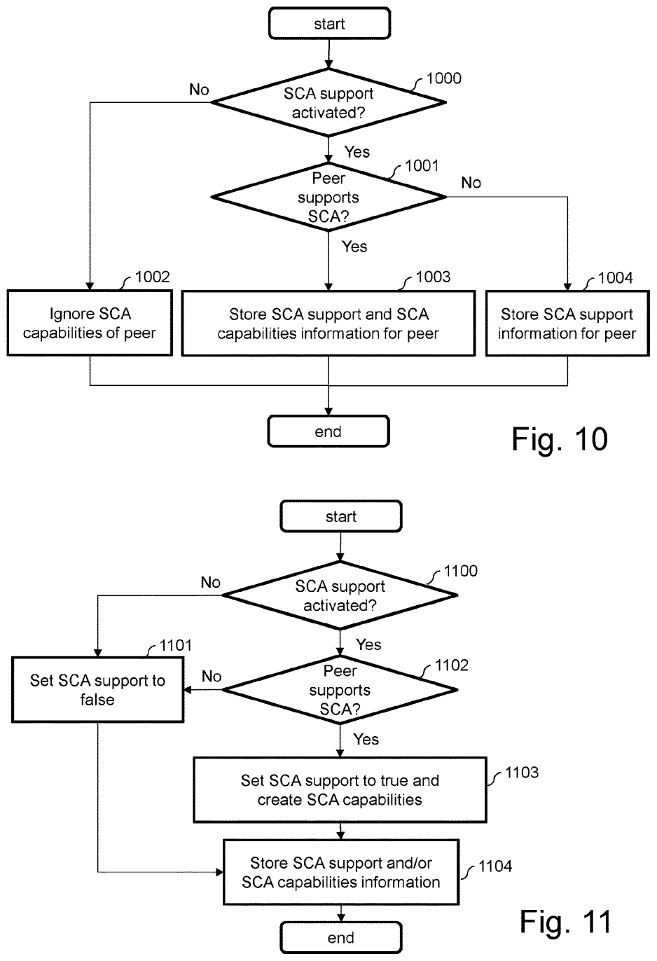

FIG. 10 illustrates, using a flowchart, exemplary steps to operate another part of SCA operation at the AP. The steps may be performed for example when the AP receives a Probe Request frame or an (Re) Association Request frame from a non-AP STA.

At step 1000, the AP checks whether SCA support is activated. This can be done by retrieving the SCA Support information stored at step 904. If SCA support is not activated, next step is step 1002 where the AP ignores SCA capabilities of the peer station (i.e., non-AP STA transmitting the frame) even if they are included in the received frame. If SCA support is activated, next step is step 1001 where the AP checks whether the peer station supports SCA. This can be done by parsing the SCA Support field according to any format of FIG. 3, that is included in the received frame. If the peer station supports SCA, next step is step 1003 where the AP stores the SCA support information and the SCA capabilities information retrieved from corresponding SCA support field and SCA capabilities field in the received frame (according to the formats described in FIGS. 3, 4 and 5). On the other hand, if the peer station does not support SCA, next step is step 1004 where the AP stores the SCA support information (i.e., SCA not supported) for the peer station. All the stored information may be stored in a non-volatile memory, such as a local register, so that the AP can refer to them in a later process. The stored information may be cached and the process may be done once for each non-AP STA as long as any of the AP and the non-AP STA do not change its configuration that is relevant to the SCA operation.

FIG. 11 illustrates, using a flowchart, exemplary steps to operate another part of SCA operation at the non-AP STA. The steps may be performed for example when the non-AP STA discovers an AP with which the non-AP STA desires to associate (e.g., by receiving Beacon frame or Probe Response frame or any other means).

At step 1100, non-AP STA checks whether SCA support is activated as described above for step 900. If SCA support is activated, next step is step 1102 where the non-AP STA checks for peer station's (i.e., AP) SCA support. This can be done parsing the SCA Support field according to any format of FIG. 3, that is included in the received frame or the like. If the peer station (AP) supports SCA, next step is step 1103 where the non-AP STA sets SCA support to true and creates SCA capabilities based on the peer station's SCA capabilities and own SCA capabilities. For example, candidate SCHs can be selected from those advertised in the peer station's SCA capabilities and that are compatible with own SCA capabilities. Own SCA capabilities may be retrieved from local register as stored at step 904. Peer station's SCA capabilities may be retrieved from the received frame (using the formats described in FIGS. 3, 4 and 5). In practice, non-AP STA usually follows the SCA capabilities indicated by the peer station and indicates its own preference of SCH only if it is allowed by AP's SCA capability. For example, if the AP indicates three SCHs in its SCH Bitmap field without any SCH Priority field, non-AP STA may select one of those SCHs based on its preference. However, if the AP indicates SCH Priority field, non-AP STA should follow the indicated priority. SCA capabilities may be further changed by reflecting the non-AP STA's wireless environment. For example, non-AP STA may know which channel is more suitable for SCA operation knowing the interference or OBSS existence in its surroundings by any means.

At step 1100, if SCA support is not activated, next step is step 1101 where the non-AP STA sets SCA support to false. At step 1102, if the peer station does not support SCA, next step is step 1101 just described.

At step 1104, the non-AP STA stores SCA support information and/or SCA capabilities information created through 1100, 1102, 1103 and 1104. All the stored information that correspond to the relationship between the non-AP STA and the peer station may be stored in a non-volatile memory, such as a local register, so that non-AP STA can refer to them in a later process. The stored information may be cached and the process may be done once for each peer station (e.g., AP) as long as any of the peer station and the non-AP STA do not change its configuration that is relevant to the SCA operation.

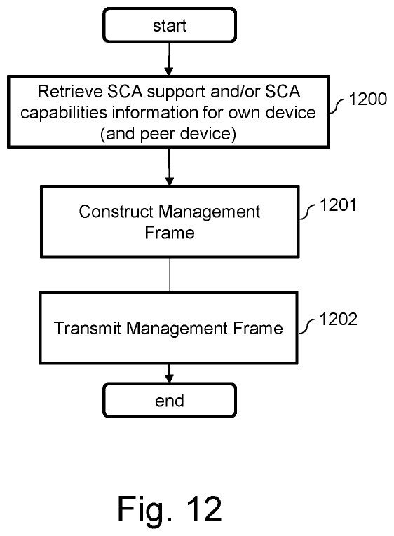

The SCA support information and/or SCA capabilities information stored through the processes of FIGS. 9, 10 and 11 can then be used by the stations to agree on SCA operations with a peer station. This is illustrated through FIG. 12.

FIG. 12 illustrates, using a flowchart, exemplary steps to operate another part of SCA operation at both the AP and the non-AP STA. The steps are performed when the station desires to send a Management frame. For the AP, it may be one of Beacon frame, Probe Response frame, (Re)Association Response frame and Action frame. For the non-AP STA, it may be one of Probe Request frame, (Re)Association Request frame and Action frame.

At step 1200, the station retrieves its SCA support information and/or SCA capabilities information and optionally those for the peer station. Such information can be retrieved from local memory as stored by the process of FIG. 9, 10 or 11. For example, the AP retrieves its own SCA support and/or SCA capabilities information for the Beacon frame using the process of FIG. 9. Furthermore, the AP may consider peer station's (i.e., non-AP STA) information for the Probe Response and (Re)Association Response using the process of FIG. 10. Similarly, the non-AP STA retrieves its own SCA support and/or SCA capabilities information for the Probe Request frame using the process of FIG. 9, while it may consider peer station's (i.e., AP) information for the Probe Request (if non-AP STA already obtained information for example from AP's Beacon frame) and (Re)Association Response using the process of FIG. 11.

At step 1201, based on the information retrieved at step 1200, the station builds the Management frame using any format described in FIGS. 3, 4 and 5. At step 1202, the station transmits the Management frame so built. The SCA support and/or SCA capabilities information included in the (Re)Association frame with status code SUCCESS (0) may be treated as meaning the SCA support and/or agreed SCA capabilities are agreed between the AP and non-AP STA that exchange the frame.

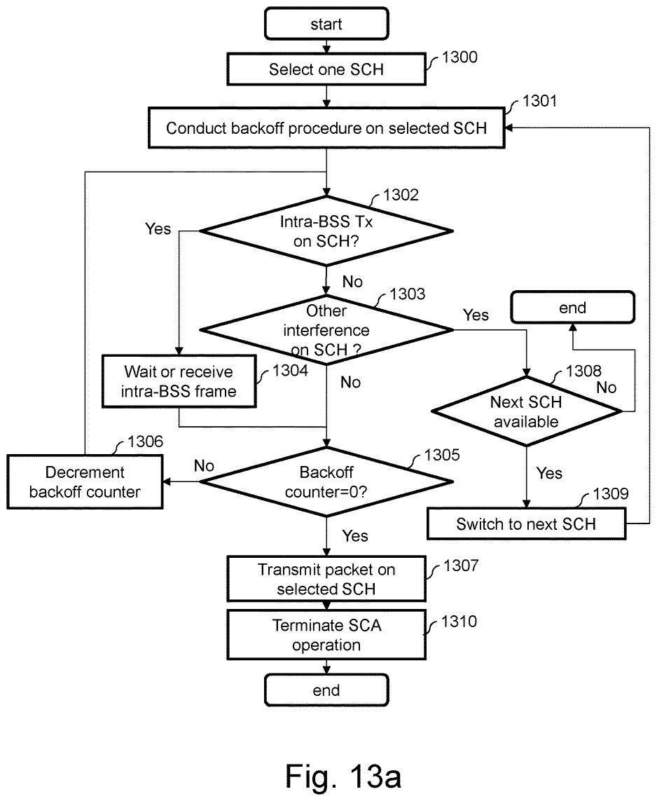

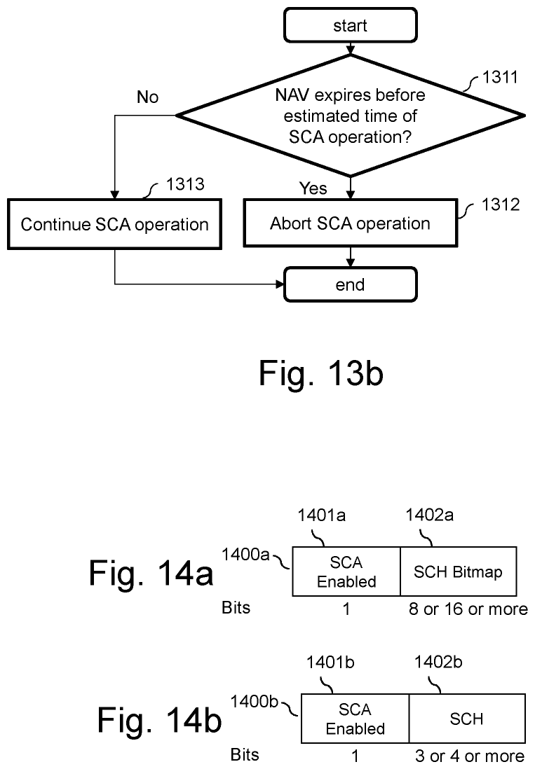

FIG. 13 illustrates exemplary steps to operate another part of SCA operation at both the AP and the non-AP STA. The steps are performed when SCA operation is triggered. SCA operation is triggered when the primary channel is not accessible due to busy CCA (including both Packet Detection and Energy Detection) as already mentioned above with reference to step 201. The processes of FIG. 13 manages the access to the medium of a SCH for SCA operation, as well as the switching from one SCH to another one for SCA operation (because a current SCH experiences activity such as busy CCA), and the switching back to the primary channel.

FIG. 13a illustrates, using a flowchart, exemplary steps of SCA management at both the AP and the non-AP STA.

At step 1300, the station (any of AP and non-AP STA) selects one candidate SCH from the agreed SCA capabilities. At step 1301, the station conducts backoff procedure on the selected SCH. At step 1302, the station checks whether intra-BSS Tx (i.e., a frame) is detected during one backoff counter period. In the affirmative, next step is step 1304 where the station waits or receives the frame if the destination address of the intra-BSS Tx is its own address and then goes to step 1305. In the negative, next step is step 1303 where the station checks whether any interference other than intra-BSS Tx is detected during the backoff counter period. If no other interference is detected, next step is also step 1305. At step 1305, the station checks whether its backoff counter reached 0. In the negative, the station decrements the backoff counter at step 1306 and goes back to step 1302. In the affirmative, the station that is granted access to the wireless medium over the selected SCH perform SCA operation over the selected SCH, such as transmission of data, packets or frame, at step 1307 and then goes to step 1310.

If another interference is detected at step 1303 (meaning the current SCH is not available), next step is step 1308 where the station checks a next SCH is available in the agreed SCA capabilities (either in the main SCH Bitmap or in the SCH Sequence of additional SCHs). In the negative, the process ends. In the affirmative, the station selects the next SCH by priority order and proceeds, at step 1309, with a switching of channel to the selected next SCH. Switching SCH may consider the values indicated in the SCH switching delay field for both AP and non-AP STA. The longer SCH switching delay may be used to align the switching time on both sides. After the SCH has been switched at step 1309, the process loops back to step 1301. In this subpart of the process, the station that determines that the current SCH is busy, switches to another SCH to perform SCA.

At step 1310, the station terminating SCA operation returns to normal operation on the primary channel, meaning it switches back to the primary channel. The station may have further data, packets or frame to transmit. To do so, the station may loop back to step 1300 to continue further SCA on the current SCH.

In some embodiments, step 1300 is extended to select multiple SCHs at once, in which case step 1301 is also extended to conduct backoff procedure (SCA) on the multiple selected SCHs. In this case, steps 1302 to 1306, 1308 and 1309 may be performed simultaneously for multiple SCHs and step 1307 may be performed over the SCH that has its backoff counter first reaching 0. In other words, the station performs simultaneously multiple SCAs on multiple SCHs of the operating channel when the primary channel is determined as being busy. In some embodiments, the other SCHs (i.e., those for which the backoff counter has not yet expired when a first one has its backoff counter reaching 0) may stop their backoff procedure. In alternative embodiments, the other SCHs may continue their backoff procedure and multiple SCHs may be used to transmit the same packet or other packets when their backoff counter reaches 0.

FIG. 13b illustrates, using a flowchart, other exemplary steps of SCA management at both the AP and the non-AP STA. They may be performed in parallel to the steps of FIG. 13a. They drive a switch back to the primary channel, based on a NAV. In particular, the proposed process provides setting a network allocation vector, NAV, mirroring an occupation of the primary channel, and terminating SCA operation on the SCH upon the NAV expiring to switch back to the primary channel to perform channel access.

The station currently is tuned on a SCH for SCA operation. Furthermore, it has knowledge of a NAV currently applicable to the primary channel of the operating channel. For example, the station may know the NAV of the primary channel if the interference occurring in the primary channel is made by OBSS and the station succeeded in obtaining the NAV duration by parsing the OBSS's packet. In other embodiments, e.g., if the interference is not caused by OBSS, the station may set a pre-defined time duration as a NAV value to drive the SCA operation during a fixed duration.

Therefore, at step 1311, the station checks whether the NAV duration for the primary channel will expire before estimated time to complete SCA operation (e.g., packet transmission at step 1307). In the affirmative, next step is step 1312 where the station aborts the SCA operation and return to the normal operation by switching back to the primary channel. In the negative, the station continues the SCA operation at step 1313. This procedure of FIG. 13b may be performed during any step of FIG. 13a or may be performed periodically such as every 10 msec (however any other period may be used).

Beyond the mere support of SCA operation, a station (either non-AP or AP station) may wish to dynamically activate and deactivate the SCA feature. For example, if STA is aware of continuing interference for all of its agreed SCHs, STA may deactivate the SCA feature. STA may reactivate its SCA operation when the interference is mitigated. The STA can also determine that different SCH or SCHs have to be considered for next communications due to detected interferences on some channels of its operating band. It is thus proposed, as described below with reference to FIGS. 14a and 14b, to use a SCA Control field with which the STA may manage its SCA operation dynamically based on its surrounding situation. Using such Control fields in MAC frames also advantageous require less overhead on the medium compared to dedicated frames to update/inform the SCH channels.

FIGS. 14a and 14b illustrate exemplary SCA Control field formats. The field may be transmitted within the MAC header of a Data frame or within an Action frame. In case of Data frame, a new HE/EHT/UHR variant of the A-Control field may be used to contain the SCA Control field but any other position within the MAC header may be used. In case of Action frame, a new Action frame may be defined, which has a new category such as UHR (Code 38). The SCA Control field is then included into one of the UHR Action frames.

1400a includes SCA Enabled field 1401a and SCH Bitmap field 1402a. SCA Enabled field 1401a signals whether SCA operation is activated till the next update or deactivated. A next update is indicated in the next SCA Control field (included either in Data frame or Action frame) sent by the transmitter. For example, if SCA Enabled field 1401a is 0, SCA operation is deactivated which means SCA operation cannot be performed by the transmitting STA even if it supports the SCA function. Otherwise, if SCA Enabled field 1401a is 1, SCA operation is activated which means SCA operation can be performed.

In the format of FIG. 14a, SCH Bitmap field 1402a may indicate which SCH or SCHs can be used or is preferred to be used until the next update. The mapping of the bits to each 20 MHz channel is identical to the usage of field 406a, except that the bits with high (1) should be selected from the SCHs agreed during the association procedure.

In the alternative format of FIG. 14b, usage of SCA Enabled field 1401b is identical to field 1401a. SCH field 1402b indicates the one SCH (from amongst those agreed during the association procedure) which can be used or is preferred to be used until the next update. The signalling in SCH field 1402b is identical to the usage of field 402c.

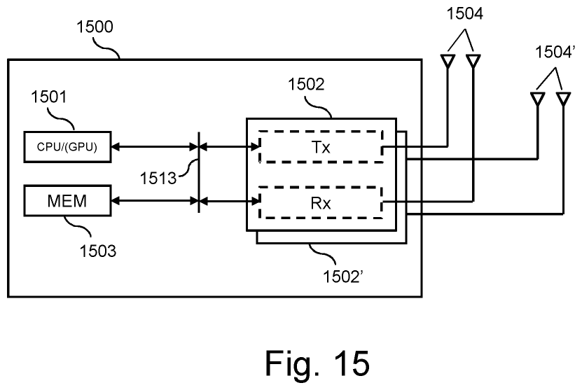

FIG. 15 schematically illustrates an example of a communication device, that may correspond to any of the stations described by reference to FIG. 1, of a wireless network, configured to implement at least some embodiments of the present invention. The communication device, referenced 1500, may preferably be a device such as a micro-computer, a workstation, or a light portable device. Communication device 1500 may comprise a communication bus 1513 to which may be connected:
a central processing unit 1501, such as a processor, denoted CPU; and optionally a graphics processing unit, denoted GPU which allows powerful computation especially required for AIML operation
a memory 1503, denoted MEM, for storing an executable code of methods or steps of the methods according to embodiments of the invention as well as the registers adapted to record variables and parameters necessary for implementing the methods; and
at least two communication interfaces 1502 and 1502′ connected to the wireless communication network, for example a communication network according to one of the IEEE 802.14 family of standards, via transmitting and receiving antennas 1504 and 1504′, respectively.

Preferably, communication bus 1513 may provide communication and interoperability between the various elements included in the communication device 1500 or connected to it. The representation of the bus is not limiting and in particular the central processing unit is operable to communicate instructions to any element of the communication device 1500 directly or by means of another element of the communication device 1500.

The executable code may be stored in a memory that may either be read only, a hard disk, or on a removable digital medium such as for example a disk. According to an optional variant, the executable code of the programs can be received by means of the communication network, via the interface 1502 or 1502′, in order to be stored in the memory 1503 of communication device 1500 before being executed.

In some embodiments, communication device 1500 may be a programmable apparatus which uses software to implement embodiments of the invention. However, alternatively, some embodiments of the present invention may be implemented, totally or in partially, in hardware (for example, in the form of an Application Specific Integrated Circuit or ASIC).

Embodiment(s) of the present invention can also be realized by a computer of a system or apparatus that reads out and executes computer executable instructions (e.g. one or more programs) recorded on a storage medium (which may also be referred to more fully as a “non-transitory computer-readable storage medium”) to perform the functions of one or more of the above-described embodiment(s) and/or that includes one or more circuits (e.g. application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), etc.), a flash memory device, a memory card, and the like.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

A person skilled in the art will readily appreciate that various parameters disclosed in the description may be modified and that various embodiments disclosed may be combined without departing from the scope of the invention.

1. A method of communication in a wireless network comprising, at a station belonging to a Basic Service Set, BSS, managed by an access point, AP, station:
in response to determining that a primary channel of an operating channel of the BSS is busy, performing channel access on a non-primary channel of the operating channel.

2. The method of claim 1, wherein the non-primary channel is previously agreed with another station of the BSS.

3. The method of claim 1, further comprising exchanging a management frame with another station of the BSS, over the primary channel, the management frame advertising the non-primary channel of the operating channel, imposed by the AP, for non-primary channel access, NPCA, and
terminating NPCA operations on the non-primary channel upon expiry of a duration set by the station, to switch to the primary channel to perform channel access.

4. The method of claim 3, wherein exchanging the management frames takes place during an association procedure between the two stations.

5. The method of claim 3, wherein the management frames include one or more of the following frames:
a beacon frame from the AP station to advertise one or more non-primary channels eligible for channel access,
a probe request frame to the AP station for the other station to advertise one or more non-primary channels eligible for channel access,
a probe response frame from the AP station to advertise one or more secondary channels eligible for channel access,
an association or reassociation request frame to the AP station for the other station to advertise one or more secondary non-primary channels eligible for channel access,
an association or reassociation response frame from the AP station to advertise one or more non-primary channels eligible for channel access.

6. The method of claim 23, wherein the other station is the AP station and, upon accessing the non-primary channel through channel access on the non-primary channel, the station exchanges frames with another non-AP station over the accessed non-primary channel.

7. The method of claim 23, wherein upon accessing the non-primary channel through channel access on the non-primary channel, the station exchanges frames with the other station over the accessed non-primary channel, wherein the station and the other station include the AP station and a non-AP station of the BSS.

8. The method of claim 1, further comprising transmitting by the station a frame including a Control field to signal whether channel access on the non-primary channel is enabled or disabled at the station.

9. The method of claim 1, wherein the station is the AP station and, upon agreeing with a non-AP station on one or more non-primary channels that form a subset of secondary non-primary channels eligible for channel access signalled in a local register of the AP station, the AP station updates the local register to the subset in order to propose the subset of non-primary channels to any other non-AP stations willing to join the BSS.

10. The method of claim 1, further comprising receiving at least two frames from at least two respective AP stations managing respective BSSs, each frame including support information signalling support of the channel access on the non-primary channel by the respective AP station and capabilities information advertising non-primary channel or channels eligible for channel access within the respective BSS in case of supported channel access on the non-primary channel,
selecting one of the AP stations based on the received support and capabilities information, and
requesting association with the selected AP station.

11. The method of claim 1, further comprising receiving a frame from a non-AP station, the frame including support information signalling support of the channel access on the non-primary channel by the non-AP station and capabilities information advertising non-primary channel or channels eligible for channel access by the non-AP station in case of supported channel access on the non-primary channel,
deciding whether to accept or refuse association of the non-AP station based on the received support and capabilities information, and
transmitting, to the non-AP station, an association response frame according to the decided acceptance or refusal.

12. The method of claim 1, wherein a frame exchanged between the station and another station of the BSS includes capabilities information advertising the non-primary channel or channels eligible for channel access in case of supported channel access on the secondary channel.

13. The method of claim 12, wherein the frame includes support information signalling support of the channel access on the non-primary channel by the station transmitting the frame and the frame includes a single Information Element to signal both support information and capabilities information.

14. The method of claim 12, wherein the frame includes support information signalling support of the channel access on the non-primary channel by the station transmitting the frame and the frame includes a first Information Element to signal the support information and a second separate Information element to signal the capabilities information.

15. The method of claim 12, wherein the capabilities information includes a bitmap that advertises which non-primary channel or channels forming the operating channel are eligible for channel access.

16. The method of claim 12, wherein the capabilities information includes a field that comprises an offset value defining a single non-primary channel eligible for channel access within the operating channel.

17. The method of claim 12, wherein the capabilities information includes a switching delay field that indicates a time needed by the transmitting station to switch from one non-primary channel to another non-primary channel to perform channel access.

18-26. (canceled)

27. A wireless communication device comprising at least one microprocessor configured for carrying out the steps of the method of claim 1.

28. A non-transitory computer-readable medium storing a program which, when executed by a microprocessor or computer system in a wireless device, causes the wireless device to perform the method of claim 1.
